(19) United States
(12) Patent Application Publication
(10) Pub. No.: US 2012/0249792 A1
(43) Pub. Date: Oct. 4, 2012

(54) DYNAMIC IMAGE STABILIZATION FOR MOBILE/PORTABLE ELECTRONIC DEVICES

(75) Inventor: Thomas B. Wilborn, San Diego, CA (US)

(73) Assignee: QUALCOMM INCORPORATED, San Diego, CA (US)

(21) Appl. No.: 13/240,979

(22) Filed: Sep. 22, 2011

Related U.S. Application Data
(60) Provisional application No. 61/470,968, filed on Apr. 1, 2011.

(51) Int. Cl. H04N 5/228; H04N 7/18

(52) U.S. Cl. 348/148; 348/208.99; 348/208.2; 348/E05.024; 348/E07.085

(57) ABSTRACT

Apparatus and methods for stabilizing an image displayed on a mobile device are presented. In some circumstances, the display on a mobile device moves with respect to the ground, which may result from vibrations in a moving vehicle. Embodiments use a sequence of images to determine a displacement of a stationary feature relative to the mobile device. This determined displacement may be a predicted displacement that estimates a displacement that probably will occur in the immediate future. Next, the displacement may be projected to a flat plane of the display. Finally, information presented on the display is moved in an opposite direction of the determined or projected displacement, thus compensating for the displacement and having the effect of stabilizing the image on the mobile device, such that the displayed image appears to be still in space even though the mobile device is vibrating or shaking relative to the Earth.

### CROSS-REFERENCE TO RELATED APPLICATIONS

This application claims the benefit of and priority under 35 U.S.C. §119(e) to U.S. Provisional Application No. 61/470,968, filed Apr. 1, 2011, titled “Dynamic image stabilization for mobile/portable electronic devices” and which is incorporated herein by reference.

### BACKGROUND

I. Field of the Invention

This disclosure relates generally to apparatus and methods for displaying an image, and more particularly to compensating for movement of the device.

II. Background

Many people cannot read for more than a brief period while traveling in a car, bus, boat, airplane, or other and moving vehicle without discomfort or feeling nauseous. The motion of a displayed image with respect to the ground makes the viewer more susceptible to motion sickness, headaches, loss of concentration, and a slower rate of reading.

Various digital techniques, such as Optical Image Stabilization (OIS), have been commercially available in mid-end to high-end cameras for several years. This technology is used to compensate for the motion of the photographer's hands with respect to the ground when taking pictures without a tripod. These systems do not adjust a displayed image, but rather a captured image.

Thus, a need exists to provide stabilized images for viewing on a platform of a mobile device.

### SUMMARY

Described is a method and apparatus for shifting the image displayed on mobile device, such as an eReader, cell phone, mobile television, laptop, notebook, netbook, smart book, or GPS device, in real-time in order to provide an image that is stable with respect to the ground, thus reducing the viewer's eye fatigue and susceptibility to motion sickness.

According to some aspects, disclosed is a method for stabilizing, with respect to Earth, an image on a display of a mobile device, the method comprising: capturing a first image from the mobile device, wherein the first image contains a stationary feature; capturing a second image from the mobile device, wherein the second image contains the stationary feature; computing a relative displacement (R_{RELATIVE}) of the mobile device based on position of the stationary feature in the first image and the stationary feature in the second image; projecting the relative displacement (R_{RELATIVE}) to a plane of the display to form a distance (R_{DISPLAY}); and moving information the distance (R_{DISPLAY}) on the display to compensate the relative displacement (R_{RELATIVE}).

According to some aspects, disclosed is a method for scrolling an image on a display of a mobile device, the method comprising: determining a relative displacement (R_{RELATIVE}) of the mobile device between a first position and a second position; projecting the relative displacement (R_{RELATIVE}) to a plane of the display to form a distance (R_{DISPLAY}); and moving information the distance (R_{DISPLAY}) on the display to compensate the relative displacement (R_{RELATIVE}).

According to some aspects, disclosed is a mobile device for stabilizing, with respect to Earth, an image on a display of a mobile device, the mobile device comprising: a processor and memory, wherein the memory comprises code for: capturing a first image from the mobile device, wherein the first image contains a stationary feature; capturing a second image from the mobile device, wherein the second image contains the stationary feature; computing a relative displacement (R_{RELATIVE}) of the mobile device based on position of the stationary feature in the first image and the stationary feature in the second image; projecting the relative displacement (R_{RELATIVE}) to a plane of the display to form a distance (R_{DISPLAY}); and moving information the distance (R_{DISPLAY}) on the display to compensate the relative displacement (R_{RELATIVE}).

According to some aspects, disclosed is a mobile device for stabilizing, with respect to Earth, an image on a display of a mobile device, the mobile device comprising: means for capturing a first image from the mobile device, wherein the first image contains a stationary feature; means for capturing a second image from the mobile device, wherein the second image contains the stationary feature; means for computing a relative displacement (R_{RELATIVE}) of the mobile device based on position of the stationary feature in the first image and the stationary feature in the second image; means for projecting the relative displacement (R_{RELATIVE}) to a plane of the display to form a distance (R_{DISPLAY}); and means for moving information the distance (R_{DISPLAY}) on the display to compensate the relative displacement (R_{RELATIVE}).

According to some aspects, disclosed is a device comprising a processor and a memory wherein the memory includes software instructions to: capturing a first image from the mobile device, wherein the first image contains a stationary feature; capturing a second image from the mobile device, wherein the second image contains the stationary feature; computing a relative displacement (R_{RELATIVE}) of the mobile device based on position of the stationary feature in the first image and the stationary feature in the second image; projecting the relative displacement (R_{RELATIVE}) to a plane of the display to form a distance (R_{DISPLAY}); and moving information the distance (R_{DISPLAY}) on the display to compensate the relative displacement (R_{RELATIVE}).

According to some aspects, disclosed is a computer-readable storage medium including program code stored thereon, comprising program code for: capturing a first image from the mobile device, wherein the first image contains a stationary feature; capturing a second image from the mobile device, wherein the second image contains the stationary feature; computing a relative displacement (R_{RELATIVE}) of the mobile device based on position of the stationary feature in the first image and the stationary feature in the second image; projecting the relative displacement (R_{RELATIVE}) to a plane of the display to form a distance (R_{DISPLAY}); and moving information the distance (R_{DISPLAY}) on the display to compensate the relative displacement (R_{RELATIVE}).

It is understood that other aspects will become readily apparent to those skilled in the art from the following detailed description, wherein it is shown and described various aspects by way of illustration. The drawings and detailed description are to be regarded as illustrative in nature and not as restrictive.

### BRIEF DESCRIPTION OF THE DRAWING

Embodiments of the invention will be described, by way of example only, with reference to the drawings.

FIG. 1 illustrates a user holding a mobile device.

FIGS. 2, 3 and 4 plot movement of a device and a stationary feature relative to Earth.

FIG. 5 shows a mobile device.

FIGS. 6 and 7 illustrate how text on the display is related to movement of the mobile device, in accordance with some embodiments of the present invention.

FIG. 8 shows a mobile device and a separate camera both mounted in a vehicle.

FIGS. 9, 10 and 11 show geometry of a mobile device relative to movement, in accordance with some embodiments of the present invention.

FIGS. 12 and 13 show two images, in accordance with some embodiments of the present invention.

FIG. 14 illustrates the block diagram, in accordance with some embodiments of the present invention.

### DETAILED DESCRIPTION

The detailed description set forth below in connection with the appended drawings is intended as a description of various aspects of the present disclosure and is not intended to represent the only aspects in which the present disclosure may be practiced. Each aspect described in this disclosure is provided merely as an example or illustration of the present disclosure, and should not necessarily be construed as preferred or advantageous over other aspects. The detailed description includes specific details for the purpose of providing a thorough understanding of the present disclosure. However, it will be apparent to those skilled in the art that the present disclosure may be practiced without these specific details. In some instances, well-known structures and devices are shown in block diagram form in order to avoid obscuring the concepts of the present disclosure. Acronyms and other descriptive terminology may be used merely for convenience and clarity and are not intended to limit the scope of the disclosure.

As used herein, a mobile device 100, sometimes referred to as a mobile station (MS) or user equipment (UE), such as a cellular phone, mobile phone or other wireless communication device, personal communication system (PCS) device, personal navigation device (PND), Personal Information Manager (PIM), Personal Digital Assistant (PDA), laptop or other suitable mobile device that is capable of receiving wireless communication and/or navigation signals. The term “mobile station” is also intended to include devices which communicate with a personal navigation device (PND), such as by short-range wireless, infrared, wire line connection, or other connection—regardless of whether satellite signal reception, assistance data reception, and/or position-related processing occurs at the device or at the PND. Also, “mobile station” is intended to include all devices, including wireless communication devices, computers, laptops, etc. which are capable of communication with a server, such as via the Internet, Wi-Fi, or other network, and regardless of whether satellite signal reception, assistance data reception, and/or position-related processing occurs at the device, at a server, or at another device associated with the network. Any operable combination of the above are also considered a mobile device 100.

The invention is a combination of software and/or hardware and sensors that dynamically adapts the location of the image displayed on a mobile device 100 to stay at a nearly constant position relative to a stationary feature. The sensors consist of accelerometers and/or cameras and/or inclinometers. Using an accelerometer the vertical distance is computed and used to compensate an image. Using a camera a vertical distance is computed based on a change in position of features between two images. That is, the mobile device 100 measures the motion of the mobile device 100 via the accelerometer and/or via the displacement of a stationary feature in images received from the camera. The mobile device 100 shifts the location of an image (panning up and down and/or panning left and right and/or zooming in and out and/or rotating left and right) in real-time to compensate for any fast change in the spatial relationship between the displayed image and Earth. The inclinometer determines the angle of the display relative to Earth so that the change in location of the image can be compensated accordingly.

Apparatus and methods for stabilizing an image displayed on a mobile device are presented. In some circumstances, the display on a mobile device moves with respect to the ground. The movement may result from vibrations in a moving vehicle. Embodiments described herein use a sequence of images (e.g., at least a first image and a second image) to determine a displacement of a stationary feature relative to the mobile device. This determined displacement may be a predicted displacement that estimates a displacement that probably will occur in the immediate future. Also, this determined displacement may be limited to vertical displacement of the mobile device in line with gravity as determined by an accelerometer. Limiting displacement to vertical displacement may better simulate movement in a bouncing vehicle. Next, the displacement may be projected to a flat plane of the display. Finally, information presented on the display (such as text and/or graphics) is moved in an opposite direction of the determined or projected displacement, thus compensating for the displacement and having the effect of stabilizing the image on the mobile device from such relative movement between the displayed image and the Earth. As such, the image displayed on a mobile device appears to a viewer to be still in space even though the mobile device is vibrating or shaking relative to the Earth.

Embodiments described herein include a windowed display such that movement of a mobile device 100 appears as a window over the displayed text or graphics. The mobile device 100 takes a two-step approach to enable the windowed display. First the mobile device 100 determines movement of the mobile device 100 relative to a stationary feature. Second, the mobile device 100 compensates for the determined movement by redisplaying the displayed image at a position and orientation opposite of the determined movement.

In some embodiments, a mobile device 100 includes a camera and a display. The mobile device 100 may use its camera to detect and track natural features in a sequence of images and determine movement of the mobile device 100 from the “movement” of natural features in the images. Next, the mobile device 100 translates or projects this movement to a displacement in a plane of a display of the mobile device 100 and then redisplays the image on the display in an equal and opposite position thus counteracting or compensating for the detected movement.

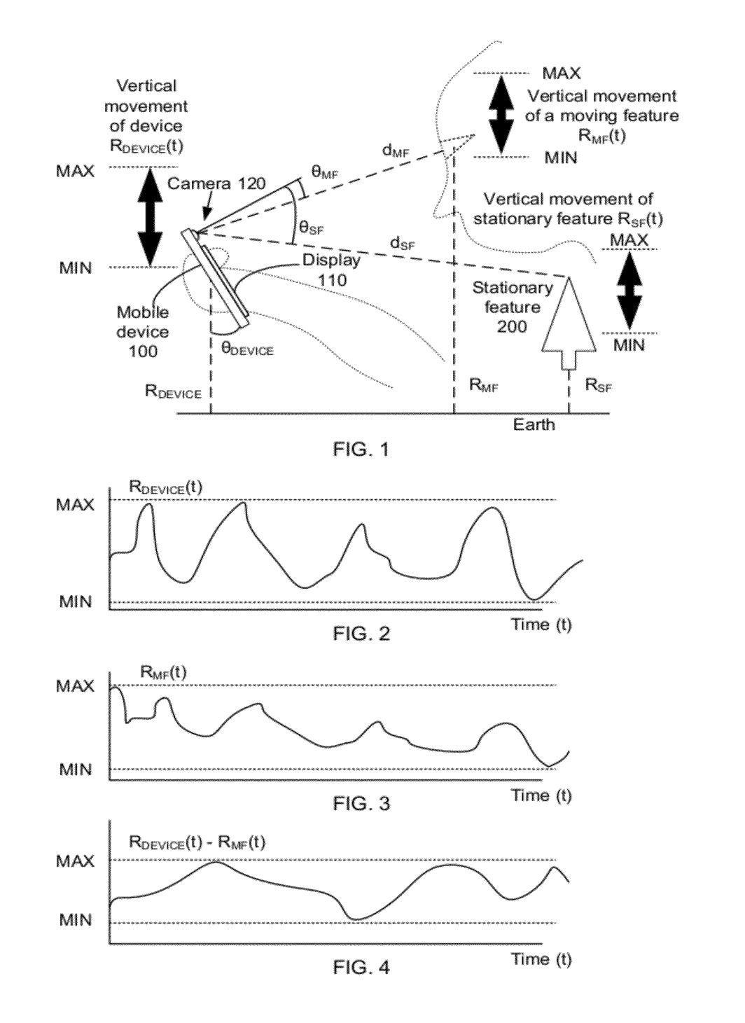

FIG. 1 illustrates a user holding a mobile device 100. The illustration includes a user holding and viewing a mobile device 100, which has a display 110 and a camera 120. A processor in the mobile device 100 uses images from the camera 120 to detect and track various features such as moving features and/or stationary features 200. A moving feature (such as a user's eye) is a feature not fixed to ground. A stationary feature (such as a tree) is a feature fixed to ground.

The processor or camera 120 may measure or estimate a distance from the mobile device 100 to one or more features. A distance to a moving feature is denoted as d_{M} and distance to the stationary feature 200 is denoted as d_{SF}. A reference angle is set at 90 degrees (perpendicular to the mobile device 100 and in a line with the center viewing angle of the camera 120). From this reference angle, a processor the mobile device 100 may compute an offset angle between the reference angle and the feature using the camera 120. For example, an offset angle between the reference angle and the moving feature is shown as θ_{MF} and an offset angle between the reference angle and the stationary feature 200 is shown as θ_{SF}. Also, the mobile device 100 is shown at a viewing angle θ_{DEVICE} offset from vertical. The viewing angle θ_{DEVICE} may be computed from inclinometer or accelerometer measurements or alternatively from processing images from the camera 120 to determine a horizontal surface or horizontal feature, such as the horizon.

While in motion the mobile device 100 and the user move up and down relative to Earth. The mobile device 100 is not fixed to Earth and its vertical movement with time is shown as R_{DEVICE}(t). Similarly the user is not fixed to Earth and its vertical movement with time is shown as R_{MF}(t). If stationary, a feature is fixed to Earth and its vertical movement with time, shown as R_{SF}(t), should be zero. If vertical movement of a feature is not zero or not close to zero, the feature is not fixed to Earth and considered a moving feature.

FIGS. 2, 3 and 4 plot movement of a mobile device 100 and moving feature relative to Earth. FIG. 2 shows a distance from Earth of a mobile device 100. While traveling, the mobile device 100 is typically within a range of a minimum value and a maximum value and oscillates between these limits A relative distance from Earth may be computed using accelerometers. An absolute distance is not necessary. FIG. 3 shows a distance from Earth of a nearby feature such as a user. FIG. 4 shows up the difference between a height of the mobile device 100 and a height of the moving feature. This relative distance may be determined from a camera image, an accelerometer or gyroscope. Using an image from the camera, the mobile device 100 determines an angle of the nearby feature with respect to a reference angle and a distance to that nearby future.

The mobile device 100 may determine an angle (θ_{MF}) and a distance to a moving feature. Similarly, the mobile device 100 may determine an angle (θ_{SF}) to a stationary feature 200. Change in the angle (θ_{SF}) to the stationary feature 200 should be entirely due to the mobile device 100. That is, if the angle (θ_{SF}) to the stationary feature 200 changes by a particular amount, than that particular amount may be associated with rotational and lateral movement of the mobile device 100. The angle (θ_{SF}) to the stationary feature 200 may be translated into movement (R_{DEVICE}(t)) of the mobile device 100 in the plane of the display 110.

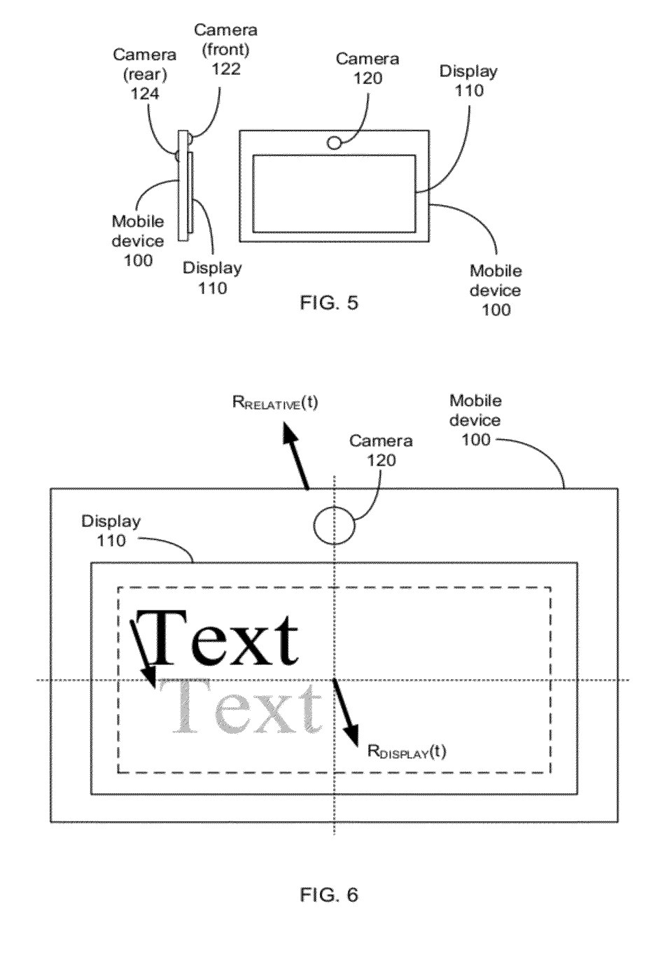

FIG. 5 shows a mobile device 100. The mobile device 100 includes a display 110 and the camera 120. The camera 120 may be on the same side of the mobile device 100 as the display 110 (shown as front camera 122) or may be on the opposite side (shown as back camera 124). Either the front camera 122 or the back camera 124 may be used to capture and track moving features and stationary features 200.

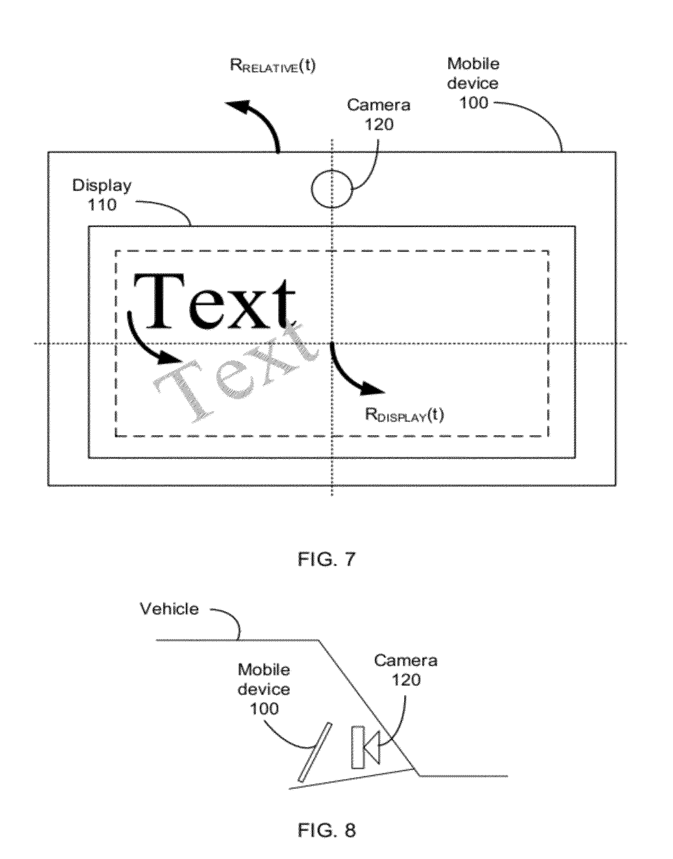

FIGS. 6 and 7 illustrate how text on the display is related to movement of the mobile device 100, in accordance with some embodiments of the present invention. The mobile device 100 may compensate for the movement (R_{DEVICE}(t)) of the mobile device 100 in the plane of the display 110 with repositioning of graphics and text on the display 110 in the opposite direction (R_{DISPLAY}(t)).

FIG. 6 shows compensation for linear movement in the plane of the display 110. For example, if the mobile device 100 determines (e.g., from the sequence of camera images) the display 110 of mobile device 100 has moved 2 mm up and 1 mm to the left, text and graphics on the display 110 may be moved down 2 mm and to the right 1 mm thereby compensating for the display plane moving. Thus, the display 110 will appear as a window over the displayed text and graphics.

In FIG. 7, the mobile device 100 compensates for rotational movement in the plane of the display 110. The mobile device 100 may track two or more features (e.g., two stationary features 200) to determine rotational movement from camera image to camera image. By observing the progression of the features from frame to frame, the mobile device 100 may determine both the pivot point, which may me either outside of or within the area of the display 110, and an angular rotation value about that pivot point. For example, if the mobile device 100 determines that the display 110 has rotated 5 degrees clockwise about the center of the display 110, the displayed image may rotate 5 degrees counter-clockwise to compensate for this movement.

FIG. 8 shows a mobile device 100 and a separate camera 120 both mounted in a vehicle. Both the mobile device 100 and the separate camera 120 provide measurements that are in a common reference system of the vehicle. Therefore, the mobile device 100 may analyze images taken from the separate camera 120 to determine lateral movement of the camera 120. The lateral movement of the camera 120 may be assumed to be the lateral movement of the mobile device 100. Therefore, as the vehicle encounters a bump (up then down), the mobile device 100 may assume it is experiencing the same movement and consequently compensate the displayed image (down then up) on the display 110. In this manner, the mobile device 100 compensates for movement in the plane of the display 110 with equal and opposite movement of the displayed image to counter detected movement of the vehicle.

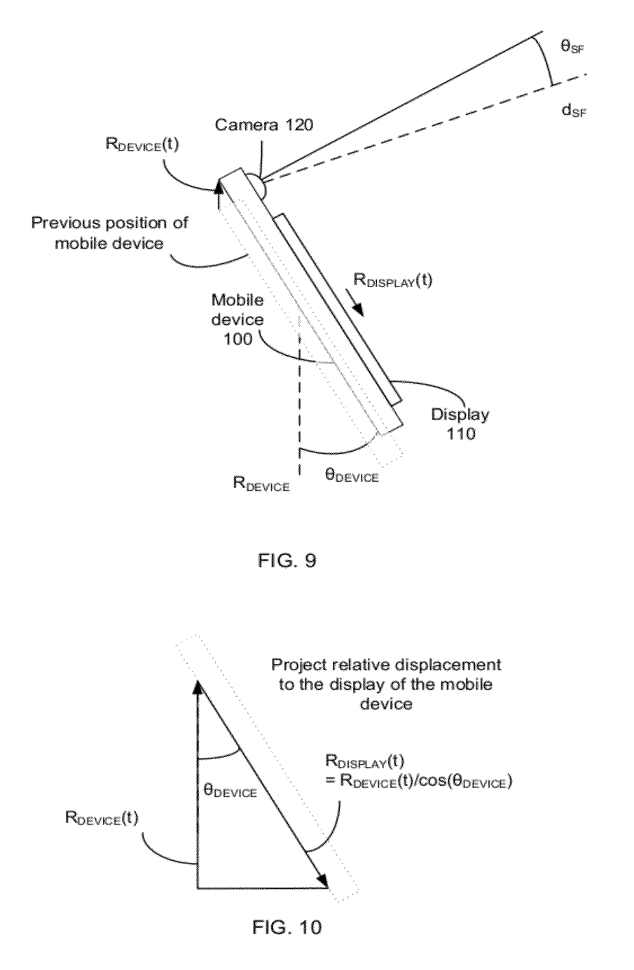

FIGS. 9, 10 and 11 show geometry of a mobile device 100 relative to movement, in accordance with some embodiments of the present invention. As shown in FIG. 9, a mobile device 100 tracks movement of one or more features, such as a moving feature or a stationary feature 200. The mobile device 100 determines that it has moved a relative distance (R_{DEVICE}(t)) from its previous position. In FIG. 10, this relative distance (R_{DEVICE}(t)) is projected to the plane of the display 110. In some cases, movement of the mobile device 100 is parallel to the display so no projection is used. In other cases, movement of the mobile device 100 is offset from the plane of the display 110 by an angle (θ_{DEVICE}) so a projection is used. The mobile device 100 may use the angle (θ_{DEVICE}) between the movement (R_{DEVICE}(t)) and the display to compute a displacement (R_{DISPLAY}(t)). For example, R_{DISPLAY}(t)=R_{DEVICE}(t)/cos(θ_{DEVICE}).

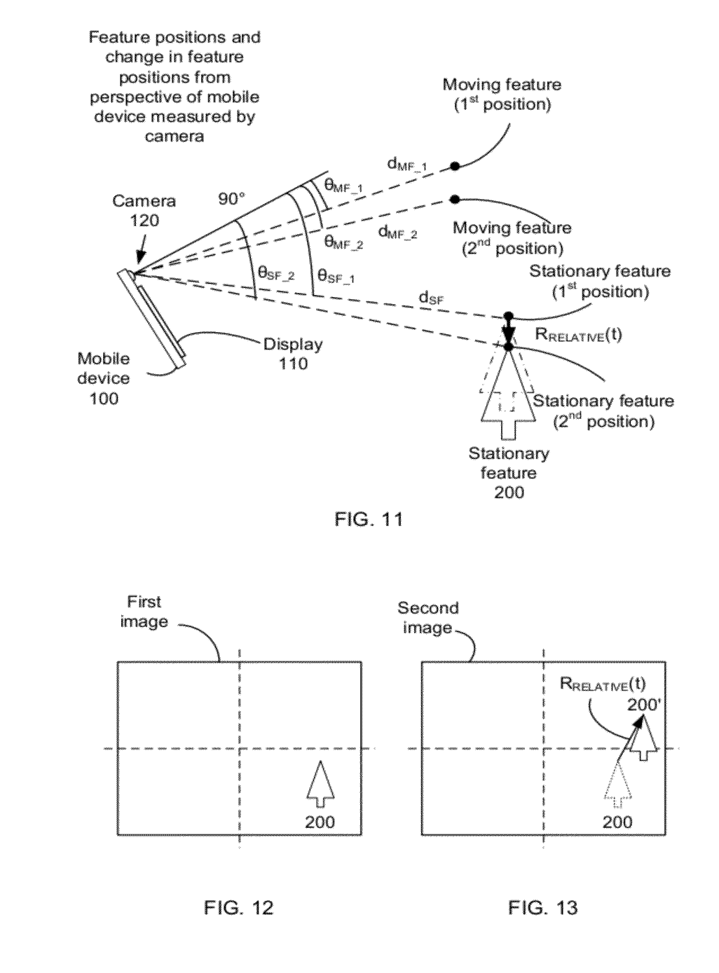

In FIG. 11, a mobile device 100 is shown determining angles and distances from a sequence of images to moving and stationary features. The mobile device 100 determines movement relative to a perpendicular angle from the display 110. For example, a stationary feature may be a point on the horizon, a building, a tree, the sun or even a cloud. In a first image, the moving feature may be at a distance d_{MF}_{_{—}}₁ and a relative angle θ_{MF}_{_{—}}₁. In a second image, the moving feature appears to move to a distance d_{MF}_{_{—}}₂ and a relative angle θ_{MF}_{_{—}}₂. Similarly, in the first image, the stationary feature, such as a tree, may be at a distance d_{SF} and a relative angle θ_{SF}_{_{—}}₁. In a second image, the stationary feature may be considered to be an equal distance away, however, the relative angle θ_{SF}_{_{—}}₂ may have moved. After tracking a feature, a processor may determine a particular feature is moving or stationary.

FIGS. 12 and 13 show two images, in accordance with some embodiments of the present invention. A first image may include one or more detected features, such as one or more stationary features 200. As shown in FIG. 12, one stationary feature 200 (e.g., a tree) is detected at a first position. In FIG. 13, the position of the stationary feature in the second image has appeared to move to a second position. In the figures, movement of features from a first position to a second position between two captured images is characterized by a relative distance R_{RELATIVE}(t). The relative distance R_{RELATIVE}(t) for each detected feature may be substantially different for various nearby and distant, stationary and moving features. A feature may be determined to be a stationary feature based on a focal distance from the camera 120 and/or based on consistent relative motion among several separated or well-spaced features in the image.

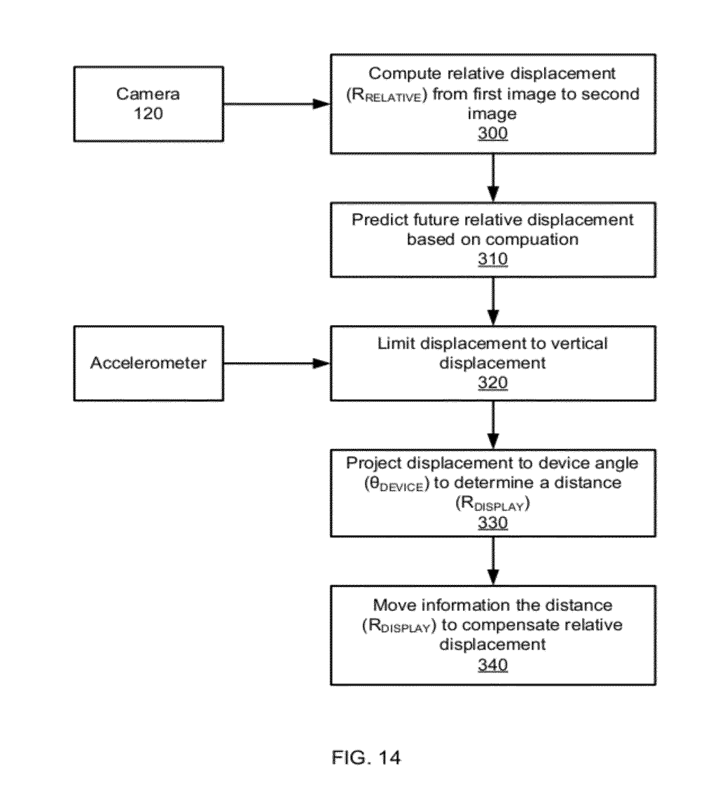

FIG. 14 illustrates the block diagram, in accordance with some embodiments of the present invention. The mobile device 100 includes a processor and memory to enable the windowed display functionality and to act as a means for performing the steps described herein. At block 300, a processor uses a sequence of camera images to compute a relative displacement of the mobile device 100 from a first image to a second image. This displacement may be relative to Earth. At block 310, the processor may optionally predict a future displacement of the mobile device 100 based on the passed displacements of the mobile device 100 recently computed at block 300. At block 320, the processor may optionally limit computed displacement to just a vertical component of the actual displacement.

At block 330, the processor may project this computed displacement to a plane of the display. For example, the processor computes an angle (θ_{DEVICE}) between the plane of the display 110 of the mobile device 100 and the direction of displacement. The displacement is projected onto the display 110 to provide a lateral adjustment of the displayed image. Similarly, the processor may compute the remainder of this projection to indicate an amount to zoom in or out of the displayed image. A zooming factor may be computed from a linear relationship between perpendicular movement and an amount of zooming. For example, 10 mm of movement may be equivalent to 5% of zooming. Alternatively, a percentage of distance change to the user may be used as a percentage of change in zooming. For example, when a user increases a distance between a user and the mobile device 100 from 10 inches to 11 inches (10%), the mobile device 100 zooms into an image by 10%.

At block 340, the processor moves information a distance (R_{DISTANCE}) equal and opposite of the projected movement to compensate for the displacement of the mobile device 100. Similarly, the processor may optionally zoom in and out of the displayed object by using the remainder of the relative displacement. That is, when the mobile device 100 moves in a direction perpendicular to the display, the processor zooms in or out of the displayed image.

In some embodiments, an accelerometer is used instead of or in conjunction with a camera 120 to determine a relative displacement of the mobile device 100. In these embodiments, the accelerometer provides measurements to a processor in the mobile device 100. The processor performs double integration to determine R_{DEVICE}(t), which may be a relative change in position of the mobile device 100 as explained above.

The windowed display described above is described for use during vibrations or handshaking or other inadvertent displacement changes that will result in small changes in the location of the displayed image. The windowed display may also be used for macro changes to pan across a document or image or scan through text. The windowed display function may also be enabled and disabled to invoke scrolling and similar features. For example, a user may read a top of page of text, then with in an enabled stated use the windowed display feature to effectively scroll down to a lower portion of the text by physically lowering the mobile device 100 to a lower portion over the text or image to be view. Next, the user may enter a disabled state where the windowed display “freezes” the displayed text or graphics. That is, when the windowed display feature is disabled, the displayed graphic and text are presented in a conventional fashion such that movement of the mobile device 100 does not affect the displayed image.

By enabling and disabling this windowed display feature, a user may scan an electronic document that is larger than the display 110 by moving the mobile device 100 “over” or across the electronic document. For example, when the windowed display is in an enabled state, a user pans to the left to view the left of the electronic document. Then a user may pan down to view a lower portion of the document. In such a manner, a user may pan across a displayed image by moving the mobile device 100 up, down, left and right.

In a similar fashion, a user may zoom in and out of a displayed image by moving the display away and toward the user. For example, when the windowed display is in an enabled state, a user may zoom into a displayed image by moving the mobile device 100 away from the user. A user may then freeze that perspective by disabling the windowed display feature and then move the mobile device 100 back towards the user to view a close up of the image. In general, the user may zoom into and out of the displayed image by moving the mobile device 100 towards and away from the user. The image may scale by a zooming factor computed from movement perpendicular to the display. By enabling and disabling the windowed display feature and moving the mobile device 100, the user may effectively pan, zoom, pull, push and freeze a document. That is, when in an enabled state, the user can pan and zoom. When in a disabled state, the user repositions the mobile device 100 while freezing the displayed image to effectively pull and push the displayed image.

The methodologies described herein may be implemented by various means depending upon the application. For example, these methodologies may be implemented in hardware, firmware, software, or any combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory and executed by a processor unit. Memory may be implemented within the processor unit or external to the processor unit. As used herein the term “memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims. That is, the communication apparatus includes transmission media with signals indicative of information to perform disclosed functions. At a first time, the transmission media included in the communication apparatus may include a first portion of the information to perform the disclosed functions, while at a second time the transmission media included in the communication apparatus may include a second portion of the information to perform the disclosed functions.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the spirit or scope of the disclosure.

1. A method for stabilizing, with respect to Earth, an image on a display of a mobile device, the method comprising:
computing a relative displacement (R_{DEVICE}) of the mobile device;
projecting the relative displacement (R_{DEVICE}) to a plane of the display to form a distance (R_{DISPLAY}); and
redisplaying information the distance (R_{DISPLAY}) on the display to compensate the relative displacement (R_{DEVICE}).

2. The method of claim 1, further comprising:
capturing a first image from the mobile device, wherein the first image contains a stationary feature; and
capturing a second image from the mobile device, wherein the second image contains the stationary feature;
wherein the act of computing the relative displacement (R_{DEVICE}) of the mobile device comprises computing the relative displacement (R_{DEVICE}) of the mobile device based on position of the stationary feature in the first image and the stationary feature in the second image.

3. The method of claim 1, further comprising:
receiving accelerometer measurements;
wherein the act of computing the relative displacement (R_{DEVICE}) of the mobile device comprises computing the relative displacement (R_{DEVICE}) of the mobile device based on the accelerometer measurements.

4. The method of claim 1, wherein computing the relative displacement (R_{DEVICE}) comprises predicting a future displacement.

5. The method of claim 1, wherein the relative displacement (R_{DEVICE}) is limited to vertical displacement.

6. The method of claim 1, wherein the information comprises text.

7. The method of claim 1, wherein the information comprises a graphical image.

8. The method of claim 1, further comprising vibrating the mobile device in a moving vehicle.

9. The method of claim 1, further comprising shaking the mobile device.

10. The method of claim 1, further comprising:
toggling between an enabled state and a disabled state;
wherein, when in the enabled state, the act of redisplaying information is enabled; and
wherein, when in the disabled state, the act of redisplaying information is disabled.

11. A method for scrolling an image on a display of a mobile device, the method comprising:
determining a relative displacement (R_{DEVICE}) of the mobile device between a first position and a second position;
projecting the relative displacement (R_{DEVICE}) to a plane of the display to form a distance (R_{DISPLAY}); and
redisplaying information the distance (R_{DISPLAY}) on the display to compensate the relative displacement (R_{DEVICE}).

12. The method of claim 11, wherein the act of determining the relative displacement (R_{DEVICE}) of the mobile device between a first position and a second position comprises processing a first image from a camera and a second image from the camera.

13. The method of claim 11, wherein the act of determining the relative displacement (R_{DEVICE}) of the mobile device between a first position and a second position comprises processing accelerometer measurements from an accelerometer in the mobile device.

14. The method of claim 11, wherein the act of determining the relative displacement (R_{DEVICE}) of the mobile device between a first position and a second position comprises processing inclinometer measurements from an inclinometer in the mobile device.

15. The method of claim 11, further comprising:
projecting the relative displacement (R_{DEVICE}) to a vector perpendicular to a plane of the display to form a zooming factor; and
scaling information on the display to compensate for the zooming factor.

16. The method of claim 12, further comprising:
toggling between an enabled state and a disabled state;
wherein, when in the enabled state, the act of scaling information is enabled; and
wherein, when in the disabled state, the act of scaling information is disabled.

17. The method of claim 11, further comprising:
toggling between an enabled state and a disabled state;
wherein, when in the enabled state, the act of redisplaying information is enabled; and
wherein, when in the disabled state, the act of redisplaying information is disabled.

18. A mobile device for stabilizing, with respect to Earth, an image on a display of a mobile device, the mobile device comprising:
a processor and memory, wherein the memory comprises code for:
capturing a first image from the mobile device, wherein the first image contains a stationary feature;
capturing a second image from the mobile device, wherein the second image contains the stationary feature;
computing a relative displacement (R_{DEVICE}) of the mobile device based on position of the stationary feature in the first image and the stationary feature in the second image;
projecting the relative displacement (R_{DEVICE}) to a plane of the display to form a distance (R_{DISPLAY}); and
redisplaying information the distance (R_{DISPLAY}) on the display to compensate the relative displacement (R_{DEVICE}).

19. A mobile device for stabilizing, with respect to Earth, an image on a display of a mobile device, the mobile device comprising:
means for capturing a first image from the mobile device, wherein the first image contains a stationary feature;
means for capturing a second image from the mobile device, wherein the second image contains the stationary feature;
means for computing a relative displacement (R_{DEVICE}) of the mobile device based on position of the stationary feature in the first image and the stationary feature in the second image;
means for projecting the relative displacement (R_{DEVICE}) to a plane of the display to form a distance (R_{DISPLAY}); and
means for redisplaying information the distance (R_{DISPLAY}) on the display to compensate the relative displacement (R_{DEVICE}).

20. A device comprising a processor and a memory wherein the memory includes software instructions to:
capturing a first image from the mobile device, wherein the first image contains a stationary feature;
capturing a second image from the mobile device, wherein the second image contains the stationary feature;
computing a relative displacement (R_{DEVICE}) of the mobile device based on position of the stationary feature in the first image and the stationary feature in the second image;
projecting the relative displacement (R_{DEVICE}) to a plane of the display to form a distance (R_{DISPLAY}); and
redisplaying information the distance (R_{DISPLAY}) on the display to compensate the relative displacement (R_{DEVICE}).

21. A computer-readable storage medium including program code stored thereon, comprising program code for:
capturing a first image from the mobile device, wherein the first image contains a stationary feature;
capturing a second image from the mobile device, wherein the second image contains the stationary feature;
computing a relative displacement (R_{DEVICE}) of the mobile device based on position of the stationary feature in the first image and the stationary feature in the second image;
projecting the relative displacement (R_{DEVICE}) to a plane of the display to form a distance (R_{DISPLAY}); and
redisplaying information the distance (R_{DISPLAY}) on the display to compensate the relative displacement (R_{DEVICE}).
